(19) United States
(12) Patent Application Publication
(10) Pub. No.: US 2026/0296380 A1
(43) Pub. Date: Oct. 1, 2026

(54) SYSTEMS AND METHODS FOR PROVIDING VEHICLE TIRE MONITORING AND ASSISTANCE

(71) Applicant: Toyota Motor Engineering & Manufacturing North America, Inc., Plano, TX (US)

(72) Inventors: Timothy Wang, Ann Arbor, MI (US); Roger Akira Kyle, Aubrey, TX (US); Bryan Else Yamasaki, Aubrey, TX (US); Justin K. Shen, Canton, MI (US); Jackson Zhu, Plano, TX (US); Xiao Xu, Novi, MI (US); Michael R. Kushnerik, Canton, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 19/089,859

(22) Filed: Mar. 25, 2025

(51) Int. Cl. B60S 5/00; G06Q 10/0875; G06T 7/00; G07C 5/04; G07C 5/08

(52) U.S. Cl. CPC B60S 5/00; G06T 7/0002; G07C 5/04; G07C 5/0833; G06Q 10/0875; G06T 2207/30252

(57) ABSTRACT

Systems and methods for calculating the lifetime of a tire and alerting a user of the tire of its status. The system may include a sensor on or adjacent to a tire on a vehicle that is configured to detect a wear condition or a damage condition of the tire. The system may further include an electronic control unit (ECU) that is coupled to the sensor and configured to estimate wear or damage to the tire, determine whether the wear or damage exceeds certain thresholds, and send a notification to a user of the vehicle that excess wear or damage to the tire has occurred. The ECU may further be able to find a store location nearby to the vehicle that has replacement tires in stock, make a reservation for a replacement tire, and guide the user of the vehicle to the store location.

### BACKGROUND

### 1. Field

The present disclosure is directed to vehicle tires, and more particularly to systems and methods for providing vehicle tire monitoring and assistance.

### 2. Description of the Related Art

Users (e.g., drivers and/or passengers) of vehicles may be reliant on the status of the vehicle's tires to successfully or optimally use or drive the vehicle. Tire monitoring systems to date are able to monitor some basic information about the tire, for example, tire pressure. However, these systems do not provide any further information about the tire such as accounting for various road and weather conditions, driving styles, and other parameters that can affect the status of a tire. Additionally, these systems do not integrate with other vehicle systems to best alert the user as to when a tire requires attention or to assist the user in finding and acquiring a replacement tire or other vehicle part. As such, these systems do not adequately assist the user with tire monitoring.

Therefore, there is a need for systems, vehicles, and methods for providing tire monitoring and tire lifetime calculations and status that also provide reminders and alarms to the user.

### SUMMARY

Systems, vehicles, and methods for providing tire monitoring are disclosed herein. A sensor may be located on or adjacent to a tire on a vehicle and may be configured to detect wear or damage to the tire. An ECU may be coupled to the sensor and configured to estimate wear or damage to the tire based on the detected wear or damage conditions. The ECU may be able to determine whether the wear or damage exceeds predetermined threshold values. The ECU may also be able to send a notification to a user of the vehicle when the wear of the tire exceeds the predetermined threshold or when damage to the tire has occurred or has been detected.

The ECU may also be able to use a GPS system of the vehicle to determine the vehicle's location. When the tire exceeds the predetermined threshold wear value or when damage to the tire has occurred or has been detected, the ECU may be able to determine which dealerships or other stores nearby to the vehicle at the time carry the type of tire that needs to be replaced. The ECU may further be able to determine which of the stores have the required tire in stock and may further be able to contact the store and reserve a tire for the user. The ECU may then also be able to guide the user to the store via provided driving directions.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a vehicle with a tire monitoring and assistance system according to an aspect of the present disclosure;

FIG. 2 illustrates a tire monitoring and assistance system according to an aspect of the present disclosure;

FIG. 3 illustrates a vehicle with a vehicle axle system according to an aspect of the present disclosure; and

FIG. 4 illustrates a flow diagram of a method for monitoring a vehicle tire and assisting the user of the vehicle with replacing the tire according to an aspect of the present disclosure.

### DETAILED DESCRIPTION

The systems, vehicles, and methods described herein assist users (e.g., drivers, passengers, vehicle owners or companies, etc.) in monitoring the status of their vehicle's tires. The vehicle may include a tire monitoring system that can monitor the status of the vehicle's tires, calculate or estimate a lifetime of the tires, remind the user when the tire is approaching the end of its expected lifetime, and alert the user when the tire should be replaced. The tire monitoring system can also determine whether there is excessive or uneven wear to one or more of the tires, potentially diagnosing an alignment, a balancing, or other vehicle condition. Some advantages of the tire monitoring system include enhanced tire safety, early diagnosis of a tire condition, determine whether the tire has been damaged as soon as the damage occurs, determine when the tire is wearing out, and notification to the user that the tire needs to be replaced. The alert or notification to the user may include information regarding nearby stores (e.g., tire service centers or dealers) to the vehicle's current location that stock the same type of tire as the tire that needs to be replaced. The tire monitoring system may confirm whether the nearby stores that stock the tire have any in stock, and if they do, the system may make a reservation for one or more of the tires and/or schedule an appointment day and time for the tire replacement or repair.

The tire monitoring system includes a sensor that can detect one or more properties of a vehicle tire or conditions related to the environment in which the tire is being used or driven on. For example, the sensor may be positioned on or near the tire for monitoring tire tread, tire wear, and/or tire damage. The sensor may also monitor for the presence of any imperfections in the tire surface, such as nails, punctures, slashes, gouges, or other potential harms to the integrity of the tire. The sensor may also monitor tire pressure. The sensor may monitor tire pressure relative to the other tires of the vehicle. The sensor may also monitor improper or uneven wear on the tire or tires indicating an alignment, a balancing, or other vehicle or tire condition. The sensor may also monitor road conditions through tracking a roughness of the road by monitoring how often and how hard the tire is bounced or jarred. The sensor may also monitor weather conditions through recording ambient temperature readings and moisture levels or through receiving data from the vehicle's GPS.

The tire monitoring system also includes an electronic control unit (ECU) connected to the sensor. The ECU is configured to store sensor data (e.g., a tire tread reading or a scan of the tire) and use the sensor data to calculate wear on the tire. The ECU may also be configured to connect to an application on a mobile device (e.g., a cell phone), an instrument cluster or other multimedia vehicle system that is able to display notifications and other alerts to the user of the vehicle. The ECU is configured to receive the gathered sensor data, calculate when the wear to the tire exceeds a predetermined threshold, determine whether there is damage to the tire, and/or notify the user when that has occurred. Further, the ECU may be configured to determine the vehicle's location, determine nearby stores that carry replacement parts (e.g., tires) for the vehicle, determine which nearby stores have the required tire(s) in stock, make a reservation for the tire at the closest store that has the tire in stock, and/or schedule an appointment day and time for the tire replacement or repair. The ECU may be able to send an alert to the user via the instrument cluster that this reservation has been made, and the ECU may also be able to prepare and send driving instructions to the instrument cluster for the user to follow in order to drive to the nearby store and purchase their replacement tire or repair their existing tire.

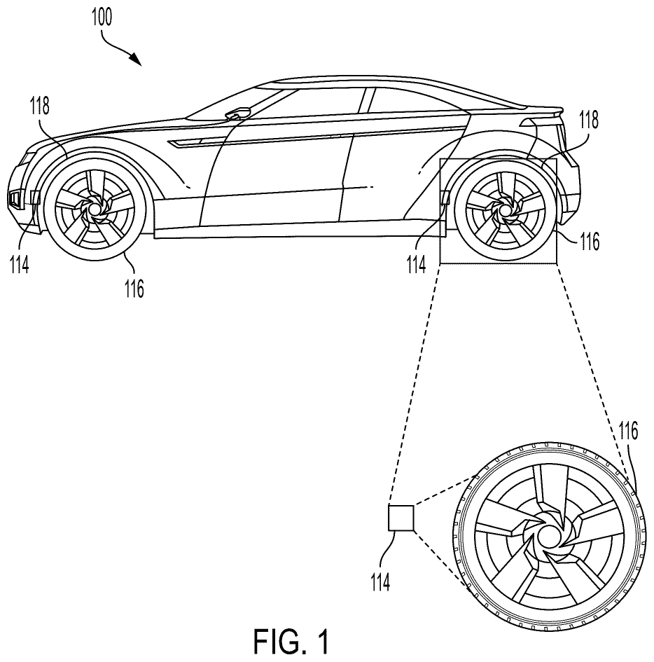

FIG. 1 illustrates a vehicle 100 with a tire monitoring and assistance system. The vehicle 100 is a conveyance capable of transporting a person, an object, or a permanently or temporarily affixed apparatus. The vehicle 100 may have an automatic or manual transmission. The vehicle 100 may be a self-propelled wheeled conveyance, such as a car, an SUV, a truck, a bus, a van or other motor or battery driven vehicle. For example, the vehicle 100 may be an electric vehicle, a hybrid vehicle, a plug-in hybrid vehicle, a fuel cell vehicle, or any other type of vehicle that includes a motor/generator.

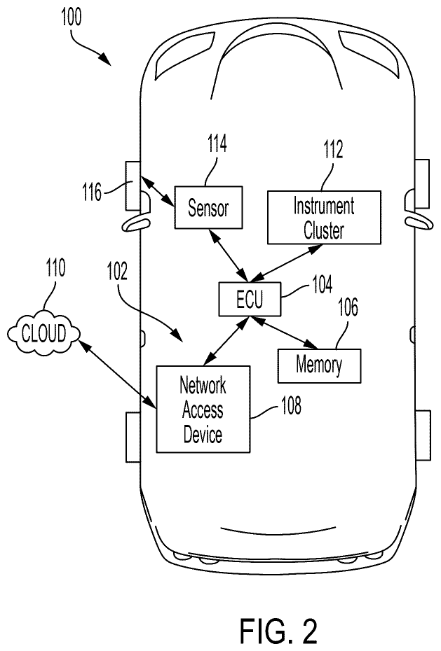

FIG. 2 illustrates a tire monitoring and assistance system 102. The vehicle 100 include a tire monitoring and assistance system 102 for providing aid to users in monitoring the status of their vehicle's tires. The tire monitoring and assistance system 102 may include an electronic control unit (ECU) 104, a memory 106, a network access device 108 that connects to the cloud 110, an instrument cluster 112, and a sensor 114 that scans and monitors a tire 116.

The ECU 104 may be coupled to each of the components of the vehicle 100 and may include one or more processors or controllers, which may be specifically designed for automotive systems. The functions of the ECU 104 may be implemented into a single ECU or multiple ECUs. The ECU 104 may receive data from components of the vehicle 100, may make determinations based on the received data, and may control the operations of the components based on the determinations. As an example, the ECU 104 can receive tire wear information from the sensor 114, determine if there are any uneven wear surfaces on the tire 116, identify the location of the tire 116, and display and notify the uneven wear surface to the driver or user on a display of the instrument cluster 112.

The vehicle 100 may be non-autonomous, fully autonomous, or semi-autonomous. In that regard, the ECU 104 may control various aspects of the vehicle 100 (such as steering, braking, accelerating, or the like) to maneuver the vehicle 100 from a starting location to a destination location. In some aspects, the vehicle 100 may be operated in an autonomous, semi-autonomous, or fully driver-operated state. In that regard, the vehicle 100 may be operated independently of driver control and, from time to time, with or without a person inside the vehicle 100. The ECU 104 may facilitate such autonomous or semi-autonomous functionality.

The memory 106 may include any non-transitory memory and may store data usable by the ECU 104. For example, the memory 106 may store map data, may store instructions usable by the ECU 104 to drive autonomously, may store data indicating actions to be taken by the ECU 104 during various environmental conditions, may store various tire data or information, or the like. The memory 106 may also store tire data collected by the sensor 114. For example, the ECU 104 may retrieve the stored data from the memory 106 to calculate or determine uneven or excessive wear on or damage to the tire 116. This can be accomplished by the sensor 114 measuring the tread depth or wear at various locations of the tire 116 and the ECU 104 identifying areas on the tire 116 that show uneven or excessive wear. As an example, the sensor 114 can measure the tread depth at various locations of the tire 116 and the ECU 104 can identify the area(s) where there is more than a, for example, 10% difference or reduction (i.e., excessive wear) in tread depth or wear amongst different areas or sections of the tire 116. This may indicate some other issues with the tire 116 or the vehicle 100. The sensor 114 can also take a photo of these areas or sections of the tire 116 and display the photo to the user using the instrument cluster 112.

The sensor 114 may be coupled to the vehicle 100 and positioned adjacent to a specific tire 116. The sensor 114 may include a camera, a radar detector, a lidar detector, an accelerometer, a thermometer, and/or any other sensor capable of detecting and measuring physical conditions of the tire 116. The sensor 114 may include one or multiple sensors which may be configured to detect multiple properties of the tire 116. For example, the sensor 114 may include a camera positioned on or near to the tire such that the camera can monitor a thickness or a depth of the tire tread and/or detect any damage to the surface of the tire, including punctures, slashes, gouges, or other damage to the tire.

The sensor 114 can scan an outside surface of the tire 116 and determines the tread depth, wear patterns, damage, and width of the tire 116 for low pressure. For example, the tire 116 being wider than normal may indicate a very low tire pressure. The sensor 114 can take initial tire readings (e.g., new tire tread depths, tire widths, treadwear indicator on side of tire, recommended tire pressures, etc.) when new tires are installed as baseline numbers for comparison to the tires 116 after use. The treadwear indicator number can also be stored in the memory 106 and be provided to the ECU 104 to help predict how long the tire 116 should last. The memory 106 can store these baseline numbers for use and comparison by the ECU 104. The sensor 114 can also detect metal nails or other metal puncture objects in case these objects are embedded into the tire 116 and cannot be visually observed or identified.

The different scans of the tire 116 are performed by the sensor 114. The scan of the tire 116 can be continuous around the entire tire 116 while the tire 116 is rotating at a vehicle speed of less than 10 miles per hour to capture substantially the entire outer surface and/or tread of the tire 116. The scan can also be while the vehicle 100 is stationary at different times and sections of the tire 116. The different times allows different portions of the tire 116 to be scanned. The scan can be vertical (e.g., around the circumference) and/or horizontal (e.g., along the width) around or across the outside surface of the tire 116.

The scan captures the tread depth, wear patterns, holes, scratches, nails, and damage or hazardous conditions to the tire 116. The scan also identifies the exact location on the tire 116 where the damaged or hazardous condition exists and displays the photo or image on a display of the instrument cluster 112 and identifies the exact tire 116 (e.g., FL, FR, RL, or RR) that needs to be inspected, repaired and/or replaced. For example, the scan can identify area(s) of the tire 116 where there is an uneven wear surface or a nail. This advantageously allows the user to know immediately when there is a potential issue with the tire 116 for enhanced vehicle safety. The ECU 104 and the sensor 114 provide for a prompt and timely inspection and reading of the tire 116 for unusual tire conditions such as uneven tread wear and damage (e.g., a nail) to the tire 116.

In an aspect, the tire monitoring and assistance system 102 includes one or more sensors 114 for each tire 116 where the sensor 114 may be positioned adjacent to or on the tire 116. For example, the one or more sensors 114 may be located inside the wheel well 118 of the vehicle 100. In an aspect, the sensor 114 can be located at or near a front portion of the wheel well 118 of the vehicle 100. The positioning of the sensor 114 at or near the front portion of the wheel advantageously protects the sensor 114 from debris or road hazards hitting the tire 116 and reflecting onto a rear portion of the wheel well 118.

The ECU 104 may be able to associate the sensor data with a particular driver or user profile. A user may be able to input a user profile ID or otherwise select a user profile when they operate the vehicle 100. The ECU 104 may be able to store any sensor data gathered when a particular user uses the vehicle 100 to their particular user profile. The ECU 104 may use this data to better predict expected wear on the vehicle tires, as one user may tend to create more wear on the tires than another user. The ECU 104 may be able to predict the wear and the life on the tires (e.g., in years and months) based on several factors discussed herein, including but not limited to, the user profile, the driver's driving habits, the treadwear rating or number on the tire, uneven wear on the tires, and/or the surrounding driving environment. Wear may be generated through a variety of factors including gas use, brake use, acceleration, average speed, distance traveled, terrain covered, racing and drifting the vehicle, or obstacles hit such as debris, curbs, rocks, potholes, or other potential driving hazards. The sensor 114 may also track ambient temperature, inside temperature, sunlight exposure, and moisture levels of the tires, and the ECU 104 may store that data and use it in calculating overall wear on the tires.

The ECU 104 may connect to the cloud 110 through a network access device 108. This connection may allow the ECU 104 to gather GPS data that the ECU 104 is able to use to determine ambient conditions of the vehicle 100, such as weather. The ECU 104 may also be able to use this connection to connect to the internet and interact with various websites and databases.

The instrument cluster 112 may include any one or more device such as a screen, a touch screen, a microphone, a speaker, or the like. The instrument cluster 112 may receive input from the ECU 104 and display it on a display screen to a user of the vehicle including a driver, a passenger, or any other person interacting with the vehicle 100.

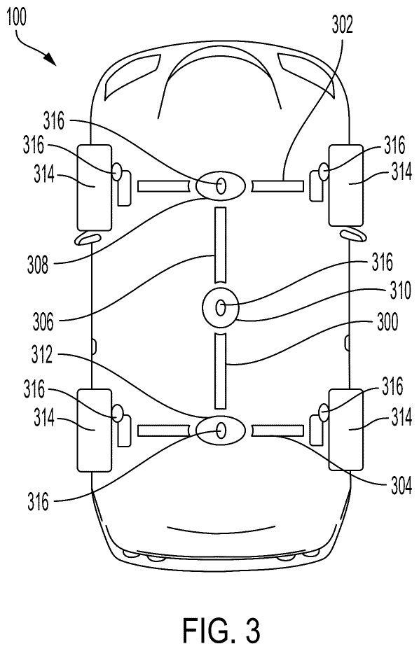

FIG. 3 illustrates the vehicle 100 with a vehicle axle system 300. The axle system 300 may connect a front axle 302 to a rear axle 304 via a driveshaft 306 or other linking assembly. The vehicle may have one or more of a front differential 308, a center differential 310, or a rear differential 312. The vehicle axle system 300 may also connect to four tires 314 on the vehicle 100. One or more sensors 316 may be located in one or more of a variety of locations on or within the vehicle 100, including on or adjacent to one or more of the tires 314, on or adjacent to the front differential 308, on or adjacent to the center differential 310, or on or adjacent to the rear differential 312. The sensor 316 may also be located elsewhere within the vehicle 100, e.g., in the wheel well 118, such that the sensor 316 is able to gather data related to the tires 314.

One or more sensors 316 may be placed on or near at least one differential of the vehicle 100 and may be configured to monitor when at least one of the four tires 314 hits a pothole or other hazard. The sensor 316 may be configured to communicate with an ECU 104 to count a number of times that potholes or other hazards have been hit, and the ECU 104 may use that data to estimate current and/or future wear on the tires 314.

One or more sensors 316 may be used to monitor the tire pressure of one or more of the tires 314. The one or more sensors 316 may be used to monitor the alignment of one or more of the tires 314. If a problem with tire pressure and/or alignment is detected, the ECU 104 may use that data to predict future wear on the tires that may happen at an accelerated rate due to a tire pressure issue, a balancing issue, and/or an alignment issue.

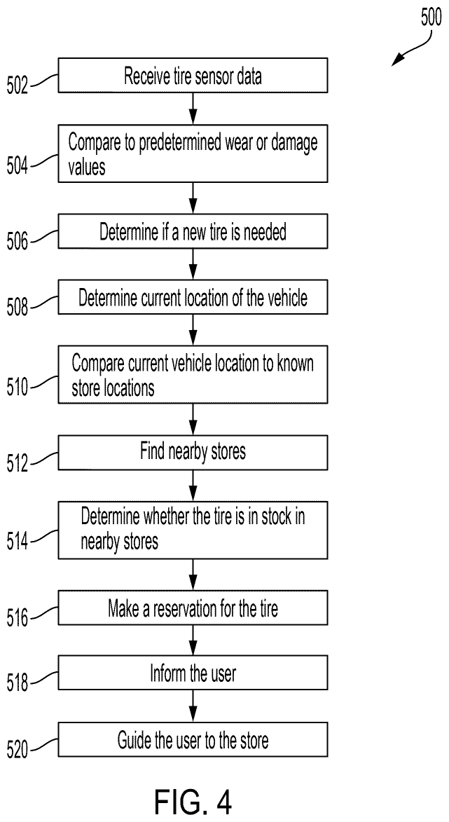

FIG. 4 illustrates a flow diagram of a method 500 for monitoring a vehicle tire and assisting the user of the vehicle with replacing the tire. At 502, a physical property of a tire is detected by a sensor (e.g. sensor 316). At 504, the tire sensor data is received by an electronic control unit (e.g. ECU 104) and is compared to a predetermined wear or damage value. At 506, the ECU determines whether a new tire is needed based on the outcome of comparing the tire sensor data to the determined wear or damage values. If a new tire is needed, at 508, the ECU determines the current location of the vehicle, such as by connecting to a GPS system of the vehicle. At 510, the ECU compares the current vehicle location to known store locations. The ECU may have a memory (e.g. memory 106) where a database of dealerships and other stores that stock parts for the vehicle is stored. At 512, the ECU determines which stores are closest to the vehicle's current location. At 514, the ECU determines whether the needed tire is in stock in these nearby stores. At 516, the ECU makes a reservation for the tire at the closest store to the vehicle's current location that has the tire in stock. At 518, the ECU informs the user that the reservation has been made. This may be, for example, the ECU sending a notification to a screen that is part of an instrument cluster that the user of the vehicle can see and/or otherwise interact with (e.g., instrument cluster 112). At 520, the ECU guides the user to the store where the reservation has been made. This may be, for example, the ECU sending driving instructions or map guidance to the instrument cluster 112 for the user to follow.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A tire monitoring system on a vehicle, the system comprising:
a sensor positioned adjacent to a tire on a vehicle and configured to detect a wear condition or a damage condition of the tire on the vehicle; and
an electronic control unit (ECU) coupled to the sensor and configured to:
estimate wear or damage to the tire on the vehicle based on the detected wear condition or damage condition,
determine whether the wear of the tire exceeds a predetermined threshold or the damage condition has occurred, and
send a notification to a user of the vehicle when the wear of the tire exceeds the predetermined threshold or the damage condition has occurred.

2. The tire monitoring system of claim 1, wherein the notification comprises a warning and an alarm and is sent to an instrument cluster or other multimedia system within the vehicle.

3. The tire monitoring system of claim 1, wherein the notification includes a location of a closest dealership or other shop where the user may purchase a replacement tire.

4. The tire monitoring system of claim 3, wherein the ECU is further configured to determine the closest dealership or other shop where the user may purchase a replacement tire by determining where the replacement tire is in stock and finding a location where the replacement tire is in stock that is closest to a current location of the vehicle.

5. The tire monitoring system of claim 4, wherein the ECU automatically makes a reservation at the location where the replacement tire is in stock for the replacement tire.

6. The tire monitoring system of claim 1, wherein the sensor comprises a camera and wherein the wear of the one or more tires estimated by the ECU represents a current condition of the one of more tires that is determined based on data gathered by the camera, including a tread thickness of the tire and the presence of any damage to a surface of the tire.

7. The tire monitoring system of claim 1, wherein the ECU is further configured to associate the detected condition of the one or more tires with a user profile.

8. The tire monitoring system of claim 7, wherein the user profile comprises a driving style determined using driving data gathered by the vehicle, wherein the driving data includes one or more of: gas use, brake use, distance traveled, terrain traversed, or obstacles hit.

9. The tire monitoring system of claim 8, wherein the ECU is further configured to:
predict future wear of the one or more tires,
estimate when the one or more tires will wear beyond the predetermined threshold, and
send a warning to the user of the vehicle with an estimated date when the one or more tires should be replaced.

10. The tire monitoring system of claim 9, wherein the ECU is further configured to determine the closest dealership or other shop where the user may purchase a replacement tire by determining where the replacement tire is in stock and finding a location where the replacement tire is in stock that is closest to a current location of the vehicle.

11. The tire monitoring system of claim 1, wherein the condition comprises mileage traveled by the one or more tires of the vehicle.

12. The tire monitoring system of claim 1, wherein the condition comprises a roughness of a road surface traveled by the one or more tires of the vehicle.

13. The tire monitoring system of claim 1, wherein the condition comprises a count of potholes and other hazards hit.

14. The tire monitoring system of claim 1, wherein the condition comprises at least one of: weather data, a temperature reading, or operational location data.

15. The tire monitoring system of claim 1, further comprising a second sensor positioned adjacent to a second tire on the vehicle.

16. A vehicle comprising:
a chassis;
a plurality of tires coupled to the chassis; and
a tire wear estimation system configured to monitor the plurality of tires, the system comprising:
at least one sensor,
an electronic control unit (ECU) in communication with the sensor,
a GPS system capable of tracking a location of the vehicle,
access to store locations that carry tires and their inventories,
an ability to contact the store locations to make a reservation for the tire, and
a user interface capable of receiving information from the ECU and displaying a notification to a user of the vehicle.

17. The vehicle of claim 16, wherein the vehicle comprises at least one differential with a differential sensor configured to monitor when at least one of the plurality of tires hits a pothole or other hazard, and wherein the differential sensor is configured to communicate with the ECU to count a number times where potholes and other hazards are hit, and wherein the ECU uses the count to estimate wear on the plurality of tires.

18. A method for monitoring a status of a tire of a vehicle, the method comprising:
measuring an amount of time the tire has been used;
determining a road condition based on signals from a sensor linked to the tire;
estimating wear of the tire by using the amount of time the tire has been used and the determined road conditions;
comparing the estimated wear to a predetermined threshold;
notifying a user of the vehicle by sending a notification to a user interface when the estimated wear exceeds the predetermined threshold;
determining the current location of the vehicle;
determining what stores within a set distance carry the tire;
determining what stores within the set distance that carry the tire have at least one tire in stock; and
making a reservation for the tire at a store that is closest to the current location of the vehicle, that carries the tire, and that has at least one tire in stock.

19. The method of claim 18, further comprising directing the user of the vehicle to the store by providing navigation directions.

20. The method of claim 18, wherein the estimating wear of the tire further comprises calculating a status of the tire using the amount of time the tire has been used, an air pressure of the tire, and data regarding typical tire wear in conjunction with the determined road conditions to predict future wear of the tire.
